(19) United States
(12) Patent Application Publication
(10) Pub. No.: US 2011/0011982 A1
(43) Pub. Date: Jan. 20, 2011

(54) MODULAR CONTROL MOMENT GYROSCOPE (CMG) SYSTEM FOR SPACECRAFT ATTITUDE CONTROL

(76) Inventors: Jason HERMAN, North Bellmore, NY (US); Kiel Davis, South Orange, NJ (US); Ron Hayes, Longmont, CO (US); Mike Passaretti, Hawthorne, NJ (US)

Correspondence Address: LEIGHTON K. CHONG;PATENT ATTORNEY, 133 KAAI STREET, HONOLULU, HI, 96821, US

(21) Appl. No.: 12/838,715

(22) Filed: Jul. 19, 2010

Related U.S. Application Data
(60) Provisional application No. 61/213,835, filed on Jul. 20, 2009.

(51) Int. Cl. B64G 1/28

(52) U.S. Cl. 244/165

(57) ABSTRACT

A modular control moment gyroscope (CMG) system for a spacecraft attitude control system (ACS) is formed by a plurality of CMG modules, wherein each CMG module has a modular enclosure design that is identical to that of the other CMG modules, such that the plurality of CMG modules are mountable in a spacecraft array bus structure in any desired one of multiple array configurations.

This U.S. Patent Application claims the priority of Provisional Patent Application No. 61/213,835, in the names of the same inventors, filed Jul. 20, 2009.

This invention was developed with research funding of the U.S. Air Force Research Laboratory, a U.S. Government agency, under Small Business Innovative Research subcontract FA9453-09-M-0177, and the U.S. Government retains certain rights therein.

### TECHNICAL FIELD

This U.S. Patent Application relates to a control moment gyroscope (CMG) system, and particularly, as used for spacecraft attitude control.

### BACKGROUND ART

A CMG system is an attitude (3D space orientation) control device generally used in spacecraft attitude control systems. A typical CMG system consists of a spinning rotor and one or more motorized gimbals that tilt the rotor's angular momentum. As the rotor tilts, the changing angular momentum causes a gyroscopic torque that rotates the spacecraft. Typically, multiple CMGs are configured in an array to achieve 3-axis attitude control. Various CMG array designs have been used, some more commonly than others.

Current satellite missions are both costly and time consuming to conduct. This is primarily driven by the need for custom components development and integration into a complete system. Current CMG systems are designed for a specific class/size satellite and must be custom modified for systems that do not conform to those specifications, thereby adding to their cost. It would be desirable to provide a CMG system that could be modularly adapted and did not need to be custom modified for a different class/size of satellite in order to reduce its cost

### SUMMARY OF INVENTION

In accordance with the present invention, a modular CMG system for a spacecraft attitude control system (ACS) comprises a plurality of CMG modules, wherein each CMG module has a modular enclosure design that is identical to that of the other CMG modules, such that the plurality of CMG modules are mountable in a spacecraft array bus structure in any desired one of multiple array configurations.

The modular CMG system employs identical CMG modules that enable it to be adapted for multiple ACS configurations and parallel CMG architectures, thereby making the system applicable to a wide range of satellite applications with a low-cost and readily available off-the-shelf solution. In addition, the discrete modules of the modular CMG system allow individual CMG modules to be discreetly distributed on a spacecraft bus structure where space is available. Because each CMG module is identical to all the others, replacement of a damaged unit is fast, simple, and inexpensive. The modular CMG system thus enables multiple array configurations, system scalability, flexible packaging, and rapid installation and removal.

Other objects, features, and advantages of the present invention will be explained in the following detailed description of the invention having reference to the appended drawings.

### BRIEF DESCRIPTION OF DRAWINGS

FIGS. 1A and 1B illustrate a basic CMG module and an array of CMG modules arranged to form a CMG system, respectively, in accordance with the present invention.

FIGS. 2A, 2B, and 2C depicts various CMG arrays that are commonly used and are easily configured using modular CMG components.

FIG. 3 depicts a basic controller architecture with provision for adding modular CMG mechanisms in parallel to expand momentum storage capacity.

### DESCRIPTION OF EMBODIMENTS

In the following detailed description of the invention, certain preferred embodiments are illustrated providing certain specific details of their implementation. However, it will be recognized by one skilled in the art that many other variations and modifications may be made given the disclosed principles of the invention.

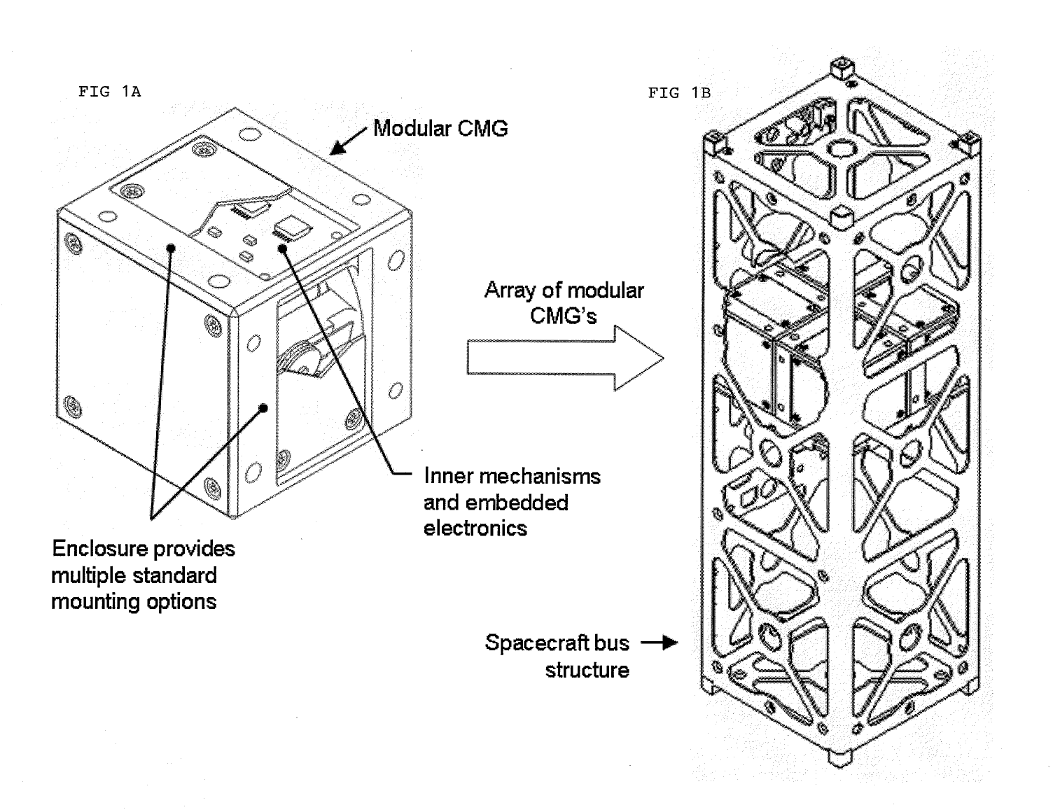

FIG. 1A depicts a CMG module in accordance with the present invention having a modular stackable and/or rackable enclosure design that allow for multiple array configurations. In the figure, the modular enclosure is shown as a parallelpiped frame, preferably cubic, which provides for multiple standard mounting options for a CMG mechanism, embedded electronics and other features (mechanical, thermal, electrical) that may be specified therein. For example, each CMG mechanism can consist of a spinning rotor and one or more motorized gimbals that tilt the rotor's angular momentum. The rotor, gimbal(s) and optionally its electronics are fully self-contained in the modular enclosure. The enclosure provides electrical, mechanical and thermal interfaces on multiple sides such that multiple options exist for mounting the CMG mechanism to the spacecraft structure.

FIG. 1B depicts how an array of CMG modules are mountable in a spacecraft array bus structure. In this figure, 4 CMG “boxes” are clustered in one bus location. A range of CMG array configurations may be easily formed by using a plurality of CMG modules having the same CMG mechanisms in various orientations with respect to each other and the spacecraft coordinate frame. Due to the self-contained nature of each CMG mechanism, it may be rapidly installed and removed from its location in the spacecraft structure without affecting the rest of the array. The velocity of each CMG mechanism's gimbal and rotor motors is controlled by a set of drive electronics which may be implemented in a central location or distributed and embedded to some extent within each CMG's mechanical enclosure.

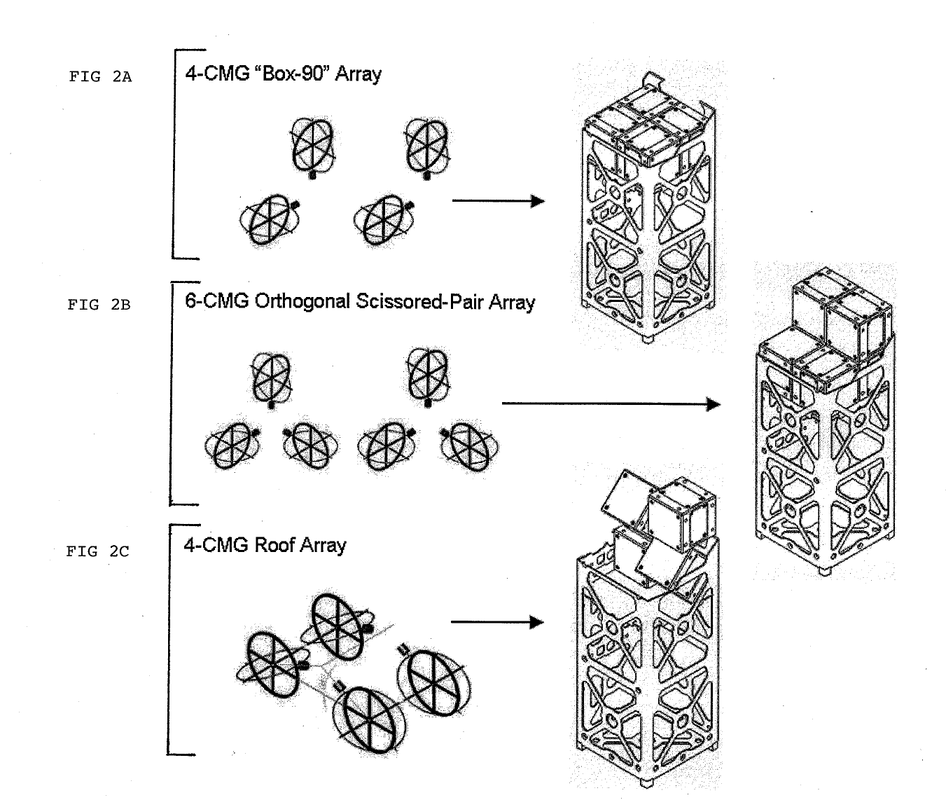

FIGS. 2A-2C depict various CMG arrays that are commonly used and easily configured in accordance with the present invention. FIG. 2A shows a 4 CMG “Box-90” array in which 4 CMG boxes are clustered together at one bus location with parallel orientation. FIG. 2B shows a 6 CMG “Orthogonal Scissored-Pair” array in which 2 sets of 3 CMG boxes in orthogonal orientation are arranged in parallel. FIG. 2C shows a 4 CMG “Roof” array.

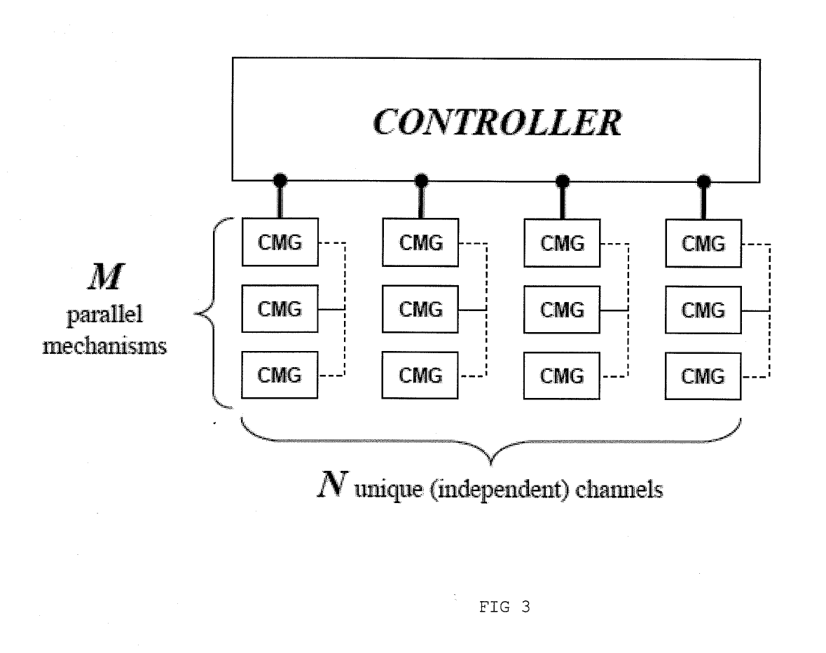

FIG. 3 depicts a basic controller architecture with novel provision for adding CMG mechanisms in parallel to expand momentum storage capacity. The control architecture provides for some number of unique channels, N, through which a single CMG mechanism can be controlled independently from the others in the array. N therefore defines the maximum number of independently controlled CMG mechanisms in the array. However, another novel feature of the control architecture is that it provides for adding some number of parallel CMG mechanisms, M, onto each unique channel thereby increasing the momentum storage capacity of the array without affecting control complexity. The total number of CMG mechanisms in the array would be M×N.

The modular CMG system allows for multiple ACS configurations and parallel CMG architectures to be employed, making the system applicable to a wide range of satellite applications with a low-cost and readily available off-the-shelf solution. In addition, the discrete modules of the invention allow individual CMG modules to be discreetly distributed on a spacecraft bus structure where space is available. Because each CMG module is identical to all the other, replacement of a damaged unit is fast, simple, and inexpensive. The modular CMG system thus enables multiple array configurations, system scalability, flexible packaging, and rapid installation and removal.

Although the present invention has been described and illustrated with respect to details of certain embodiments, it is to be clearly understood that the same is by way of illustration and example only and is not to be taken by way of limitation, the spirit and scope of the present invention, as defined in the following claims.

1. A modular control moment gyroscope (CMG) system for a spacecraft attitude control system (ACS) comprising a plurality of CMG modules, wherein each CMG module has a modular enclosure design that is identical to that of the other CMG modules, such that the plurality of CMG modules are mountable in a spacecraft array bus structure in any desired one of multiple array configurations.

2. A modular CMG system according to claim 1, wherein said modular enclosure is a parallelpiped frame with multiple standard mounting options for CMG components therein.

3. A modular CMG system according to claim 2, wherein said modular enclosure has a cubic frame.

4. A modular CMG system according to claim 1, wherein said modular enclosure contains a CMG mechanism, embedded electronics and other specified features mounted within the enclosure of the frame.

5. A modular CMG system according to claim 4, wherein each CMG mechanism consists of a spinning rotor and one or more motorized gimbals that tilt the rotor's angular momentum.

6. A modular CMG system according to claim 1, further comprising a controller architecture with provision for adding CMG modules in parallel to expand momentum storage capacity, wherein said control architecture has a plurality N of unique channels, each of which controls a sub-plurality of CMG modules and through which a single CMG module of said sub-plurality can be controlled independently from the others in said array configuration.

7. A modular CMG system according to claim 6, wherein said controller architecture has a plurality M of parallel control lines for CMG modules in said array configuration having a total number of CMG modules of M×N.

8. A method of configuring a modular control moment gyroscope (CMG) system for a spacecraft attitude control system (ACS) comprising the steps of: providing a plurality of CMG modules, wherein each CMG module has a modular enclosure design that is identical to that of the other CMG modules, and mounting a selected number of said identical CMG modules in a spacecraft array bus structure according to a desired array configuration.

9. A method of configuring a modular CMG system according to claim 8, further comprising providing a controller architecture with provision for adding CMG modules in parallel to expand momentum storage capacity, wherein said control architecture has a plurality N of unique channels, each of which controls a sub-plurality of CMG modules and through which a single CMG module of said sub-plurality can be controlled independently from the others in said array configuration.

10. A method of configuring a modular CMG system according to claim 9, wherein said controller architecture has a plurality M of parallel control lines for CMG modules in said array configuration having a total number of CMG modules of M×N.
